(19) United States
(12) Patent Application Publication
(10) Pub. No.: US 2026/0087605 A1
(43) Pub. Date: Mar. 26, 2026

(54) Rolling Shutter Artifact Correction And Metadata Integration For Geospatially Accurate Imaging Systems

(71) Applicant: Skydio, Inc., San Mateo, CA (US)

(72) Inventors: Roy Vorster, San Francisco, CA (US); Abraham Galton Bachrach, Emerald Hills, CA (US); Joseph Anthony Enke, San Carlos, CA (US)

(21) Appl. No.: 19/339,873

(22) Filed: Sep. 25, 2025

Related U.S. Application Data
(60) Provisional application No. 63/699,060, filed on Sep. 25, 2024.

(51) Int. Cl. G06T 5/80; G06T 5/73

(52) U.S. Cl. CPC G06T 5/80; G06T 5/73; G06T 2207/10032

(57) ABSTRACT

Disclosed is a vehicle equipped with a rolling shutter image sensor, a gimbal, an inertial measurement unit (IMU), and a global navigation satellite system (GNSS) module. The processor in the system generates a warp mesh to correct rolling shutter artifacts using pose data, exposure time, and an estimated scene geometry. This correction approximates a global shutter capture, and both raw and corrected images are stored with embedded metadata, including timestamp, camera orientation, and geolocation. The system can handle gimbal orientation changes, optimize images for photogrammetry, and correct motion blur and scene motion. It also supports various operational modes such as base station, total station, and differential leveling, and can stream real-time digital twin models. The method involves capturing images, recording pose data, computing correction meshes, and saving images with metadata, enabling high-precision geolocation and image correction.

### CROSS-REFERENCE TO RELATED APPLICATIONS

This application claims the benefit of U.S. Provisional Patent Application No. 63/699,060, filed on Sep. 25, 2024, the contents of which are incorporated herein by reference in their entirety.

### TECHNICAL FIELD

The disclosure relates to systems and methods for correcting rolling shutter distortions in images captured by a vehicle, utilizing motion data and geolocation information to enhance image accuracy and metadata integration.

### BACKGROUND

Unmanned aerial vehicles (UAVs), commonly referred to as drones, are increasingly used across diverse industries for applications such as aerial photography, surveying, mapping, agriculture, construction, and environmental monitoring. By equipping drones with high-resolution cameras, operators can capture detailed imagery from unique vantage points, producing valuable datasets for analysis and decision-making.

A significant limitation, however, arises from the widespread use of rolling shutter cameras in these systems. Unlike global shutter sensors, which expose all pixels simultaneously, rolling shutter sensors capture an image line by line over a short interval. When the drone or the scene is in motion, this sequential capture leads to distortions such as skew, wobble, or “jello” artifacts. These errors degrade the geometric integrity of the imagery and are especially problematic in precision-driven applications like surveying, 3D reconstruction, and the creation of digital twins of physical environments.

To overcome these challenges, there is a critical need for technologies that can correct rolling shutter distortions either in real time during flight or through efficient post-processing. Furthermore, as demand for high-quality, survey-grade aerial imagery continues to grow, the development of integrated solutions for rolling shutter correction represents a key area of innovation in drone technology and geospatial imaging.

### SUMMARY

The techniques described herein relate to systems and methods that may include a drone equipped with a rolling shutter image sensor and a gimbal. The system can have an inertial measurement unit (IMU) to provide pose data of the camera during exposure and a global navigation satellite system (GNSS) module for RTK or PPK positioning. The processor may generate a warp mesh to correct rolling shutter artifacts using pose data, per-row exposure time, and an estimated scene geometry, e.g., an assumed ground plane. The processor can apply the warp mesh to create a corrected image approximating a global shutter capture, store both raw and corrected images, and embed metadata such as timestamp, corrected camera orientation, and geolocation from the GNSS module.

In some implementations, the processor may seamlessly handle changes in gimbal orientation when applying rolling shutter correction. Metadata can further include a description of the warp mesh used for correction. Corrected images may be optimized for third-party photogrammetry packages assuming a global shutter pinhole camera model. The processor can correct motion blur by modeling the camera's motion during each pixel's exposure interval and adjusting pixel values based on IMU data or successive image frames.

In some implementations, the processor may reduce errors caused by scene motion during capture by identifying moving objects using at least one of a prior frame, a subsequent frame, or a stored 3D model of the scene, and adjusting the warp mesh for pixels corresponding to the moving object. The warp mesh can be computed using a multi-plane or depth-aware model, allowing different regions of the image to be warped according to estimated depth values derived from stereoscopic imagery, LiDAR, or an online SLAM system.

In some implementations, the processor may selectively store either only the corrected image, only the raw image, or both, based on a user-selectable setting that toggles correction output modes. Metadata can further include exposure timing data, sensor readout direction, and environmental parameters affecting calibration, enabling reconstruction software to replicate or refine the applied correction. The corrected image may be tagged with survey-grade geospatial metadata, including at least one of ellipsoidal altitude, RTK ambiguity status, number of satellites used, or geodetic dilution of precision (GDOP).

In some implementations, the processor can detect ground control point (GCP) markers in the image and update the embedded geolocation metadata of the corrected image based on the known coordinates of the marker. The processor may operate in a base station mode, allowing the drone, when stationary on or above a known reference point, to log GNSS observations and broadcast RTK corrections to other rovers. The processor can operate in a total station mode, where the gimbal directs a camera or range sensor at a target point, and the processor computes the coordinates of the target point using the drone's RTK position and orientation.

In some implementations, the processor may operate in a differential leveling mode, where the drone compares its reference altitude at a first location to the altitude of a second location observed by its sensors to determine elevation difference. The processor can perform a real-time digital twin streaming mode, where corrected images and associated metadata are processed onboard and transmitted in real-time to generate a continuously updated 3D model of the environment.

In some implementations, a method is disclosed that may involve capturing an image with a rolling shutter camera on a drone while in motion, recording pose data during exposure, computing a correction warp mesh based on pose data, timing information, and an estimated scene geometry, e.g., an estimated ground plane, warping the image to approximate a global shutter image, and saving the warped image with metadata including RTK or PPK position, camera orientation, and exposure timestamp.

In some implementations, the method can dynamically update the estimated scene geometry using real-time vision-based altitude detection. Correction may reduce rotational artifacts using IMU data and translational artifacts using velocity-based scene plane warping. A three-dimensional reconstruction can be generated using corrected images without requiring ground control points. Motion blur compensation may involve determining the camera's motion during pixel exposure intervals using inertial data or successive images and adjusting pixel values inversely to the determined motion.

In some implementations, the scene motion correction can involve identifying a moving object using at least one of a prior image, a subsequent image, or a known scene model, and adjusting the warp for pixels corresponding to the moving object. Computing the warp mesh may involve using a multi-plane or depth-aware model, where different portions of the image are warped according to depth estimates obtained from stereoscopic imagery, LiDAR, or SLAM-based depth mapping.

In some implementations, the method may store both a raw image and the corrected image, or alternatively only one of them, based on a user-selectable mode toggle. Saving metadata can include embedding at least one of exposure timing data, sensor readout direction, or environmental parameters used to generate the warp mesh. The method may detect a ground control point (GCP) marker within the image and refine the image geolocation metadata based on the known coordinates of the marker.

In some implementations, the method can operate the drone in a base station mode, where the drone, while stationary, logs GNSS data and transmits RTK corrections to other devices. The method may operate the drone in a total station mode, where the drone directs a gimbal-mounted sensor toward a target point and computes the coordinates of the target using the drone's RTK position and orientation.

In some implementations, the method can operate the drone in a differential leveling mode, where the drone determines an elevation difference between two locations by comparing its reference altitude to an observed point's altitude using gimbal and onboard sensors. The method may stream corrected images and associated metadata in real-time to generate a continuously updated digital twin of the environment.

In some implementations, a non-transitory computer-readable medium is disclosed that may store instructions that, when executed, cause a processor to determine a plane depth below the drone using at least one of a digital terrain model, takeoff altitude, or real-time vision estimation, compute a warp mesh for rolling shutter correction based on the determined plane depth and drone motion during exposure, apply the warp mesh to the image, and output both the corrected image and the raw image with associated geolocation metadata.

In some implementations, a system may include a drone with a rolling shutter camera, a navigation module for RTK or PPK geolocation, and a processor to correct rolling shutter distortions using motion data and an estimated scene plane, storing corrected images with geolocation metadata. The processor can correct both rotational and translational rolling shutter artifacts. The scene plane may be estimated based on takeoff altitude, terrain model, or real-time vision data.

In some implementations, corrected images can be warped into a rectilinear camera model. The drone may operate as a survey instrument by performing base station mode, differential level mode, total station mode, or laser scanning. The method may broadcast RTK corrections from the drone to a remote device and generate a real-time digital twin using corrected images.

In some implementations, a system for correcting rolling shutter distortions in vehicle imagery may include a navigation module for high precision geolocation techniques and a processor to correct image distortions using movement information and approximated scene geometry, storing processed images with positioning metadata. High precision geolocation techniques can include RTK or PPK geolocation. Movement information may include motion data captured during image acquisition.

In some implementations, approximated scene geometry can include an estimated scene plane. The processor may correct both rotational and translational rolling shutter artifacts. The estimated scene plane can be determined based on takeoff altitude, a digital terrain model, or real-time vision data. The processor may warp corrected images into a rectilinear camera model. The vehicle can operate as a survey instrument by performing base station mode, differential level mode, total station mode, or laser scanning.

In some implementations, the processor may seamlessly handle gimbal orientation changes when applying rolling shutter correction. Positioning metadata can further include a description of a warp mesh used for correction. Processed images may be optimized for third-party photogrammetry packages assuming a global shutter pinhole camera model. A method for correcting rolling shutter distortions in vehicle imagery may involve providing high precision geolocation techniques, correcting image distortions using movement information and approximated scene geometry, and storing processed images with positioning metadata.

In some implementations, the method can broadcast real-time kinematic (RTK) corrections from the vehicle to a remote device and generate a real-time digital twin using processed images. The method may dynamically update the approximated scene geometry using real-time vision-based altitude detection. Correcting image distortions can include reducing rotational artifacts using inertial measurement unit (IMU) data and reducing translational artifacts using velocity-based scene plane warping. A three-dimensional reconstruction may be generated using processed images without requiring ground control points.

Various other aspects, features, and advantages of the disclosed embodiments will be apparent through the detailed description and the drawings attached hereto. It is also to be understood that both the foregoing general description and the following detailed description are examples, and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a part of, or the entirety of (i.e., the entire portion), a given item (e.g., data) unless the context clearly dictates otherwise.

### BRIEF DESCRIPTION OF THE DRAWINGS

FIG. 1 illustrates an example configuration of a top side of an unmanned aerial vehicle (UAV), consistent with various embodiments.

FIG. 2 illustrates an example configuration of a bottom side of the UAV, consistent with various embodiments.

FIG. 3 illustrates an example UAV architecture, consistent with various embodiments.

FIG. 4 illustrates a schematic diagram depicting the rolling shutter correction process, consistent with various embodiments.

FIG. 5 illustrates a schematic diagram depicting the correction process for transforming images captured by a rolling shutter camera on a drone into a format that simulates a global shutter capture, consistent with various embodiments.

FIG. 6 is a block diagram illustrating an embodiment of the correction system, consistent with various embodiments.

FIG. 7 is a flowchart illustrating a method for correcting rolling shutter distortions in images captured by a drone, consistent with various embodiments.

FIG. 8 is a flowchart illustrating a method for correcting rolling shutter distortions in vehicle imagery, consistent with various embodiments.

FIG. 9 is a flowchart illustrating a method for correcting rolling shutter distortions in vehicle imagery, consistent with various embodiments.

Embodiments will now be described in detail with reference to the drawings, which are provided as illustrative examples so as to enable those skilled in the art to practice the embodiments. Notably, the figures and examples below are not meant to limit the scope to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the embodiments will be described, and detailed descriptions of other portions of such known components will be omitted so as not to obscure the description of the embodiments. In the present specification, an embodiment showing a singular component should not be considered limiting; rather, the scope is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the scope encompasses present and future known equivalents to the components referred to herein by way of illustration.

### DETAILED DESCRIPTION

To overcome the limitations of conventional imaging systems, there is a critical need for technologies that can correct rolling shutter distortions either in real time during flight or through efficient post-processing. High-accuracy geolocation data—such as real-time kinematic (RTK) or post-processed kinematic (PPK) positioning—combined with motion data from onboard sensors provides the foundation for such corrections. By leveraging these data sources, image processing systems can estimate scene geometry, compute time-aligned camera poses, and transform rolling shutter captures into outputs that approximate global shutter images.

The disclosed embodiments offer significant advantages over conventional systems. For example, unlike traditional approaches that rely on costly global shutter cameras or slow stop-and-capture workflows, the present systems enable the use of lightweight, high-resolution rolling shutter sensors while still delivering survey-grade accuracy. By applying real-time or post-processed warp correction based on motion data, exposure timing, and estimated scene geometry, the disclosed technology reduces both rotational and translational artifacts, resulting in imagery that more closely resembles a global shutter capture. Integration with RTK/PPK geolocation ensures that corrected images are georeferenced with centimeter-level precision, minimizing or eliminating the need for ground control points. In addition, the system seamlessly handles edge cases such as gimbal orientation changes and can embed correction metadata directly into image files for compatibility with third-party photogrammetry software. These improvements simplify user workflows, improve the reliability of 2D and 3D reconstructions, and broaden access to high-precision mapping by making it feasible on more affordable and versatile vehicle platforms.

Disclosed are embodiments providing a method and system for correcting rolling shutter distortions in images captured by a vehicle. The system may include a drone equipped with a rolling shutter camera, a navigation module for real-time kinematic (RTK) or post-processed kinematic (PPK) geolocation, and a processor. The processor can generate a warp mesh to correct rolling shutter artifacts using motion data, pose data, and an estimated scene plane. The corrected images may be stored with geolocation metadata, including timestamp and camera orientation. The system may also handle gimbal orientation changes seamlessly during the correction process. Additionally, the corrected images can be optimized for third-party photogrammetry packages, assuming a global shutter pinhole camera model. The system may operate in various modes, such as base station mode, total station mode, and differential leveling mode, to perform surveying tasks. The method may involve capturing images, recording motion and position data, estimating a scene plane, and applying warp corrections to generate corrected images. The system and method may enhance image quality and accuracy for applications requiring precise geolocation and image correction.

In some implementations, the rolling shutter image sensor may be utilized to capture images that are subject to distortions due to the rolling shutter effect. The processor may be configured to generate a warp mesh, which can be applied to correct these rolling shutter artifacts. This correction may be based on various parameters, including pose data, per-row exposure time, and an assumed ground plane. The warp mesh may be generated to address the distortions by approximating a global shutter capture, thereby enhancing the image quality. The corrected images may then be stored alongside the raw uncorrected images, allowing for a comprehensive data set that includes both the original and processed imagery. The metadata embedded within the corrected images may include information such as timestamps, corrected camera orientation, and geolocation data derived from the GNSS module. This metadata may serve to provide context and enhance the utility of the images in various applications, such as photogrammetry or digital twin generation. The system may also incorporate motion data and scene plane estimation to further refine the correction process, ensuring that both rotational and translational artifacts are addressed. The integration of these components and actions may facilitate a robust solution for rolling shutter correction, potentially improving the accuracy and reliability of the captured imagery.

In some implementations, corrected images may be stored with metadata, which can include geolocation metadata, camera orientation, and a timestamp. The processor may be responsible for embedding this metadata into the images. The metadata embedding process may serve the purpose of data storage and metadata embedding, allowing the corrected images to be stored with location data. The processor may embed metadata, including the timestamp, corrected camera orientation, and geolocation, to ensure that the images are stored with comprehensive metadata. This process may involve the use of a processor to handle the embedding of metadata, which may include geolocation metadata, camera orientation, and a timestamp. The corrected images may be stored with geolocation metadata, which may provide valuable information about the location and orientation of the camera at the time of image capture. The metadata embedding process may be crucial for ensuring that the images are stored with accurate and detailed metadata, which may be used for various purposes, such as data analysis and image processing. The processor may play a key role in this process, as it may be responsible for embedding the metadata into the images. The metadata may include information such as the timestamp, corrected camera orientation, and geolocation, which may be essential for understanding the context of the image capture. The corrected images may be stored with this metadata, which may enhance their value and utility for various applications.

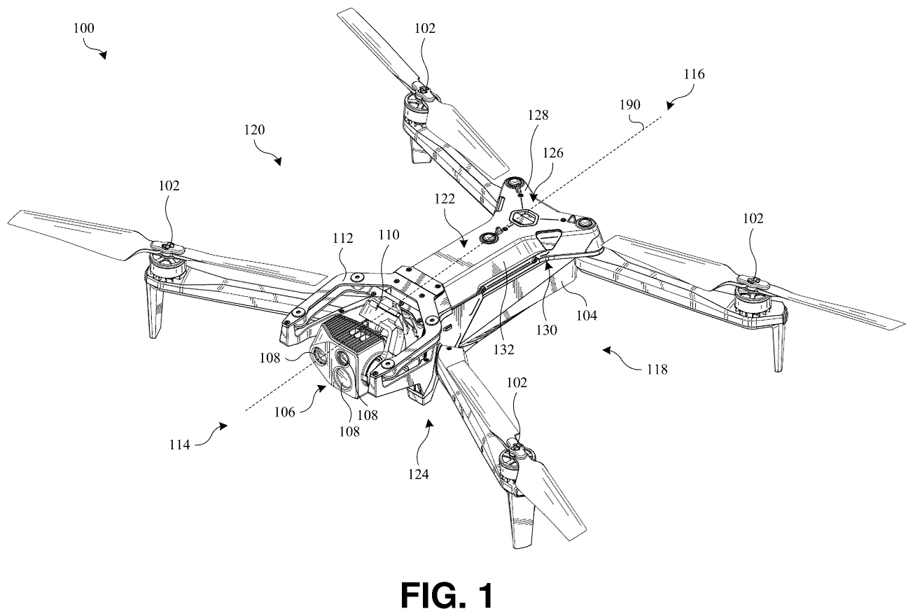

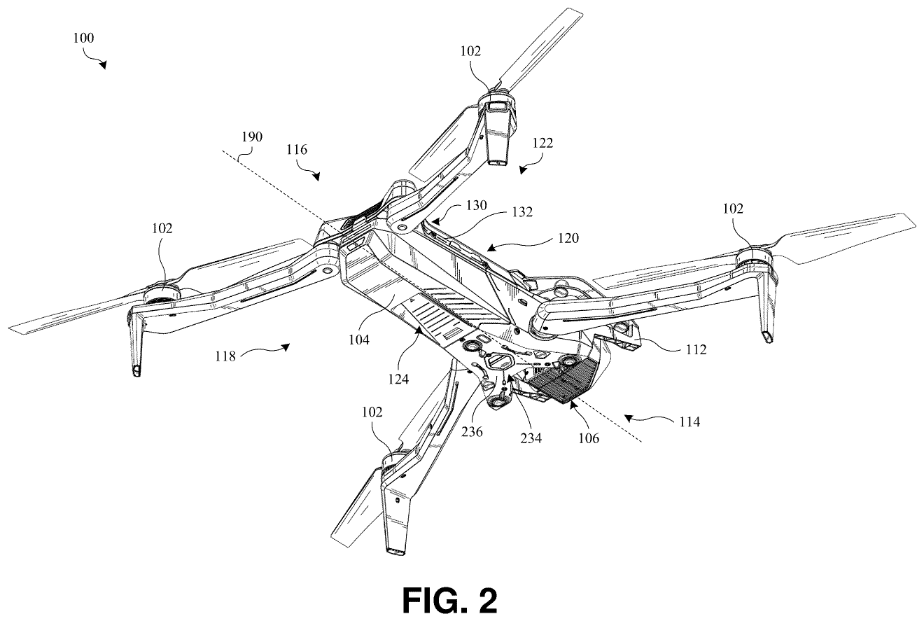

Turning now to the figures, FIG. 1 illustrates a top perspective view of an unmanned aerial vehicle (UAV) 100. FIG. 2 illustrates a bottom perspective view of the UAV 100.

The UAV 100 may include one or more propulsion mechanisms 102 and a power source, such as a battery coupled to the UAV 100. The UAV 100 may be configured for autonomous landing and/or docking with a docking station. To support the autonomous landing and/or docking, the UAV 100 may follow any suitable processes or procedures, or may include one or more components, such as those described in U.S. application Ser. No. 16/991,122, filed Aug. 12, 2020, and U.S. Provisional Application No. 63/527,261, filed on Jul. 17, 2023, the entire disclosures of which are hereby incorporated by reference for all purposes.

The propulsion mechanisms 102 may include any components and/or structures suitable for supporting flight of the UAV 100. For example, as shown in FIGS. 1 and 2, the propulsion mechanisms 102 may be or may include propeller assemblies having one or more blades connected to hubs of the UAV 100. The one or more blades may be propelled by a motor to rotate the one or more blades and facilitate flight of the UAV 100, whereby the motor may be powered by a power source of the UAV 100, such as the battery 104. It should be appreciated, however, that the configuration and/or structure of the UAV 100 may vary depending on the particular configuration of the UAV 100, and as such, the UAV 100 shown in FIG. 1 is not intended to limit the structure of the UAV 100.

As mentioned above, the UAV 100 may be configured using various processes or protocols to autonomously land (e.g., on a docking station), to autonomously take flight (e.g., from a docking station), or both. To facilitate autonomous landing and/or autonomous flight, the UAV 100 may include one or more sensors, such as image sensors, that are configured to monitor a position of the UAV 100 and/or detect a specified image, such as a fiducial disposed on a docking station. For example, during a landing sequence (e.g., a docking sequence) of the UAV 100, the image sensors of the UAV 100 may detect an image, such as the fiducial disposed on the docking station, to properly align and guide the UAV 100 to dock.

The UAV 100 may further include a camera system 106. The camera system 106 may be configured to detect, monitor, capture, record, or a combination thereof one or more images. The camera system 106 may be configured to facilitate autonomous or user-controlled flight of the UAV 100. For example, the camera system 106 may include one or more cameras 108. The cameras 108 may capture a live feed of an environment during flight, whereby a user via a user interface (e.g., a controller) may control the UAV 100 based upon the live feed of the environment. Alternatively, or additionally, the cameras 108 may capture images of the environment and/or monitor the environment in real-time to autonomously fly through the environment. It should be noted that the cameras 108 and the camera system 106 are not limited to any particular configuration, and any types of camera configurations (e.g., wide-angle, high-resolution, etc.) may be implemented in the UAV 100.

The camera system 106 may be operable via a gimbal system 110 coupled to the camera system 106. The gimbal system 110 may be configured to be controlled autonomously or via a user interface (e.g., a controller) to orient or otherwise move the camera system 106 (e.g., the cameras 108) relative to the UAV 100. The gimbal system 110 may include one or more arms and one or more pivot joints that facilitate movement of the camera system 106 relative to the UAV 100.

The gimbal system 110 and the camera system 106 may be coupled to the UAV 100 by a mounting bracket 112. The mounting bracket 112 may be coupled to the UAV 100 by one or more fasteners or other mechanical connection means to secure the gimbal system 110 and the camera system 106 to the UAV 100. The mounting bracket 112 may be coupled to any portion of the UAV 100. By way of example, as shown in FIGS. 1 and 2, the mounting bracket 112 may be coupled to a front 114 (i.e., a front side) of the UAV 100 or a top 122 (i.e., a top side) of the UAV 100 such that the camera system 106 may be positioned in the front 114 of the UAV 100.

That is, the camera system 106 may be located at the front 114 (i.e., the front side) of the UAV 100 so that the cameras 108 may capture an environment in front of the UAV 100 with respect to a forward direction of travel of the UAV 100 (e.g., a direction of travel of the UAV 100 that is substantially parallel to the ground or along the ground). However, in certain configurations, the camera system 106 may also be coupled to another portion of the UAV 100, such as a rear 116 (i.e., rear side) of the UAV 100, a first side 118 of the UAV 100, a second side 120 of the UAV 100, a bottom 124 (i.e., a bottom side) of the UAV 100, or a combination or variation thereof.

As discussed in further detail below, one or more attachments may be coupled to the UAV 100 and operable with the UAV 100 to further customize a user experience of the UAV 100. That is, the one or more attachments may be coupled to the UAV 100 to provide additional functionality to the UAV 100. For example, the one or more attachments may be a global positioning system (GPS) attachment, a microphone and/or speaker attachment, a night vision attachment (e.g., infrared (IR) attachment), a spotlight attachment, a secondary power source attachment (e.g., a secondary battery similar to the battery 104), an antenna or other radio accessory, a secondary camera system similar to or different from the camera system 106, a computer module, or a combination thereof. Thus, it is envisioned that any type of attachments or arrangement of multiple attachments may be configured for securement to the UAV 100. Additionally, as discussed in further detail below, the UAV 100 or a system thereof may be dynamic such that one or more characteristics (e.g., features, functionalities, operations, etc.) of the UAV 100 may be automatically and dynamically adjusted based upon a type of attachment coupled to the UAV 100.

To facilitate coupling one or more attachments to the UAV 100, the UAV 100 may include one or more attachment interfaces. As shown in FIGS. 1 and 2, the UAV 100 may include a plurality of attachment interfaces located on the UAV 100. For example, the UAV 100 may include a top attachment interface 126 located on the top 122 (i.e., the top side) of the UAV 100, a side attachment interface 130 located on the first side 118 of the UAV 100, a side attachment interface 130 located on the second side 120 of the UAV 100 that opposes the first side 118, and a bottom attachment interface 234 located on the bottom 124 (i.e., the bottom side) of the UAV 100.

To further illustrate positioning of such attachment interfaces, as shown in FIGS. 1 and 2, the UAV 100 (e.g., a body of the UAV 100 from which the propulsion mechanisms 102 extend) may extend along a longitudinal axis 190 of the UAV 100 from the front 114 of the UAV 100 to the rear 116 of the UAV 100. That is, the UAV 100 may extend from a first end (e.g., the front 114, which may be considered a forward end of the UAV 100) to an opposing second end (e.g., the rear 116, which may be considered an aft end of the UAV 100) along the longitudinal axis 190, whereby a length of the UAV 100 or a body thereof may be measured from the first end to the second end.

Moreover, the first side 118 of the UAV 100 may oppose the second side 120 of the UAV 100 with respect to the longitudinal axis 190. The first side 118 and second side 120 may be located on opposing sides of the longitudinal axis 190. The first side 118 may be considered a port side of the UAV 100 and the second side 120 may be considered a starboard side of the UAV 100.

Based on the above relative orientations, it can be seen in FIGS. 1 and 2 that the attachment interfaces described above may be positioned in various locations with respect to the longitudinal axis 190 of the UAV 100. For example, the top attachment interface 126 and/or the bottom attachment interface 234 may be located on the top 122 (i.e., the top side) of the UAV 100 and may extend along the longitudinal axis 190 between the first end (e.g., the front 114 or forward end) and the second end (e.g., the rear 116 or aft end) of the UAV 100. Additionally, the side attachment interfaces 130 may be located on the first side 118 and the second side 120 of the UAV 100 such that the side attachment interfaces 130 may be located on opposing sides of the longitudinal axis 190. That is, a first one of the side attachment interfaces 130 may be located on the port side (e.g., the first side 118) of the UAV 100 and a second one of the side attachment interfaces 130 may be located on the starboard side (e.g., the second side 120) of the UAV 100 such that the side attachment interfaces 130 are located on opposing sides of the longitudinal axis 190.

It should be noted that the above relative orientations associated with the UAV 100 are provided for illustrative purposes and should not be construed as limiting the teachings herein. For example, although the front 114 of the UAV 100 may be considered the front end of the UAV 100 and the rear 116 of the UAV 100 may be considered the aft end of the UAV 100, such considerations do not mean that the UAV 100 only travels in a forward direction with the front 114 of the UAV 100 leading the travel. That is, the UAV 100 may travel in any direction (e.g., fore, aft, side-to-side between the port and starboard sides, in an elevational direction, etc.) with respect to the longitudinal axis 190.

Turning now back to the attachment interfaces, it should be noted that such attachment interfaces may be integrated into the UAV 100, such as a housing of the UAV 100, or may be connected to the UAV 100 to allow for attachment of various attachments. That is, the attachment interfaces may provide a connection means to easily and removably couple various attachments to the UAV 100.

By way of example, the top attachment interface 126 may include a top attachment surface 128. The top attachment surface 128 may be located on, or formed with, the top (i.e., the top side) of the UAV 100. The top attachment surface 128 may be configured to receive, support, or otherwise couple to - either directly or indirectly - various attachments. Similarly, the side attachment interfaces 130 may include a side attachment surface 132 located on, or formed with, the first side 118 and/or the second side 120 of the UAV 100. Moreover, the bottom attachment interface 234 may include a bottom attachment surface 236 located on, or formed with, the bottom 124 (i.e., the bottom side) of the UAV 100. Any number of these attachment surfaces may exist for any of the attachment interfaces. That is, an attachment interface may include more than one attachment surface (e.g., a first attachment surface and a second attachment surface).

Based on the above, one or more attachments may be coupled to the top 122 of the UAV 100, the bottom 124 of the UAV 100, the first side 118 of the UAV 100, the second side 120 of the UAV 100, or a combination thereof. Additionally, it is envisioned that the front 114 and/or the rear 116 of the UAV 100 may also in certain configurations include an additional attachment interface. For example, in certain configurations the UAV 100 may remove the camera system 106 from the front 114 of the UAV and couple the camera system 106 to the UAV 100 in another location (e.g., the rear 116). In such a configuration, the front 114 may include an attachment interface for further attachments.

It should also be noted that the attachment interfaces of the UAV 100 may be adapted for universal or common attachment techniques. That is, various types of attachments may be coupled to the same attachment interface. For example, the GPS attachment and the night vision attachment may both be configured to attach to the top attachment interface 126 and the bottom attachment interface 234. Additionally, more than one attachment may be coupled to the UAV 100 at one time and may be powered by the power source (e.g., the battery 104) of the UAV 100. For example, a first attachment (e.g., a GPS attachment) may be coupled to the top attachment interface 126 and a second attachment (e.g., a spotlight attachment) may be coupled to the side attachment interface 130 located on the first side 118 of the UAV 100. Moreover, the attachment interfaces may include one or more additional features, such as heat-sinking components or other cooling components. Based on the above, various configurations and customization may be possible.

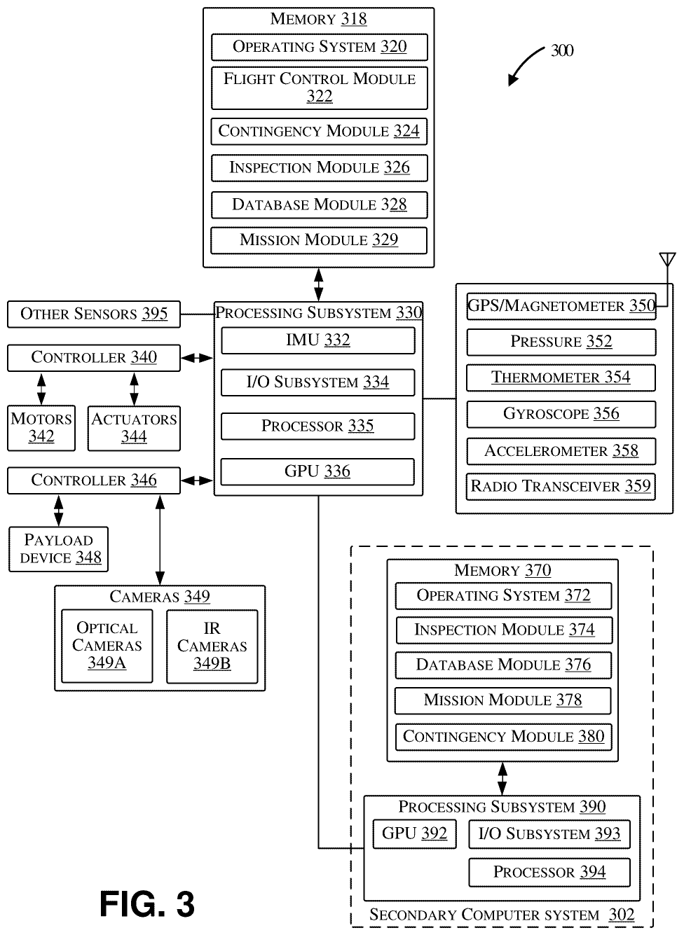

FIG. 3 illustrates an example UAV architecture, consistent with various embodiments. In the examples herein, the UAV 100 may sometimes be referred to as a “drone” and may be implemented as any type of UAV capable of controlled flight without a human pilot onboard. For instance, the UAV 100 may be controlled autonomously by one or more onboard processors, such as processor 335, that execute one or more executable programs. Additionally, or alternatively, the UAV 100 may be controlled via a remote controller, such as through a remotely located controller operated by a human pilot and/or controlled by an executable program executing on or in cooperation with the controller.

A UAV can include a primary computer system 300 and a secondary computer system 302. The UAV primary computer system 300 can be a system of one or more computers, or software executing on a system of one or more computers, which is in communication with, or maintains, one or more databases. The UAV primary computer system 300 can include a processing subsystem 330 including one or more processors 335, graphics processing units 336, I/O subsystem 334, and an inertial measurement unit (IMU) 332. In addition, the UAV primary computer system 300 can include logic circuits, analog circuits, associated volatile and/or non-volatile memory, associated input/output data ports, power ports, etc., and include one or more software processes executing on one or more processors or computers. The UAV primary computer system 300 can include memory 318.

Memory 318 may include non-volatile memory, such as one or more magnetic disk storage devices, solid-state hard drives, or flash memory. Other volatile memory such as RAM, DRAM, SRAM may be used for temporary storage of data while the UAV is operational. Databases may store information describing UAV flight operations, flight plans, contingency events, geofence information, component information and other information.

The UAV primary computer system 300 may be coupled to one or more sensors, such as global navigation satellite system (GNSS) receivers 350 (e.g., GPS receivers), thermometer 354, gyroscopes 356, accelerometers 358, pressure sensors (static or differential) 352, and other sensors 395 that capture perception inputs of a physical environment. The other sensors 395 can include current sensors, voltage sensors, magnetometers, hydrometers, anemometers and motor sensors. The UAV may use IMU 332 in inertial navigation of the UAV. Sensors can be coupled to the UAV primary computer system 300, or to controller boards coupled to the UAV primary computer system 300. One or more communication buses, such as a controller area network (CAN) bus, or signal lines, may couple the various sensor and components.

Various sensors, devices, firmware and other systems may be interconnected to support multiple functions and operations of the UAV. For example, the UAV primary computer system 300 may use various sensors to determine the UAV's current geo-spatial position, attitude, altitude, velocity, direction, pitch, roll, yaw and/or airspeed and to pilot the UAV along a specified flight path and/or to a specified location and/or to control the UAV's attitude, velocity, altitude, and/or airspeed (optionally even when not navigating the UAV along a specific flight path or to a specific location).

The flight control module 322 handles flight control operations of the UAV. The module interacts with one or more controllers 340 that control operation of motors 342 and/or actuators 344. For example, the motors may be used for rotation of propellers, and the actuators may be used for flight surface control such as ailerons, rudders, flaps, landing gear and parachute deployment.

The contingency module 324 monitors and handles contingency events. For example, the contingency module 324 may detect that the UAV has crossed a boundary of a geofence, and then instruct the flight control module 322 to return to a predetermined landing location. The contingency module 324 may detect that the UAV has flown or is flying out of a visual line of sight (VLOS) from a ground operator, and instruct the flight control module 322 to perform a contingency action, e.g., to land at a landing location. Other contingency criteria may be the detection of a low battery or fuel state, a malfunction of an onboard sensor or motor, or a deviation from the flight plan. The foregoing is not meant to be limiting, as other contingency events may be detected. In some instances, if equipped on the UAV, a parachute may be deployed if the motors or actuators fail.

The mission module 329 processes the flight plan, waypoints, and other associated information with the flight plan as provided to the UAV in a flight package. The mission module 329 works in conjunction with the flight control module 322. For example, the mission module may send information concerning the flight plan to the flight control module 322, for example waypoints (e.g., latitude, longitude and altitude), flight velocity, so that the flight control module 322 can autopilot the UAV.

The UAV may have various devices connected to the UAV for performing a variety of tasks, such as data collection. For example, the UAV may carry one or more cameras 349. Cameras 349 can include one or more visible light cameras 349A, which can be, for example, a still image camera, a video camera, or a multispectral camera. The UAV may carry one or more infrared cameras 349B. Each infrared camera 349B can include a thermal sensor configured to capture one or more still or motion thermal images of an object, e.g., a solar panel. In addition, the UAV may carry a Lidar, radio transceiver, sonar, and traffic collision avoidance system (TCAS). Data collected by the devices may be stored on the device collecting the data, or the data may be stored on non-volatile memory 318 of the UAV primary computer system 300.

The UAV primary computer system 300 may be coupled to various radios, e.g., transceivers 359 for manual control of the UAV, and for wireless or wired data transmission to and from the UAV primary computer system 300, and optionally a UAV secondary computer system 302. The UAV may use one or more communications subsystems, such as a wireless communication or wired subsystem, to facilitate communication to and from the UAV. Wireless communication subsystems may include radio transceivers, infrared, optical ultrasonic and electromagnetic devices. Wired communication systems may include ports such as Ethernet ports, USB ports, serial ports, or other types of port to establish a wired connection to the UAV with other devices, such as a ground control station (GCS), flight planning system (FPS), or other devices, for example a mobile phone, tablet, personal computer, display monitor, other network-enabled devices. The UAV may use a lightweight tethered wire to a GCS for communication with the UAV. The tethered wire may be affixed to the UAV, for example via a magnetic coupler.

The UAV can generate flight data logs by reading various information from the UAV sensors and operating system 320 and storing the information in computer-readable media (e.g., non-volatile memory 318). The data logs may include a combination of various data, such as time, altitude, heading, ambient temperature, processor temperatures, pressure, battery level, fuel level, absolute or relative position, position coordinates (e.g., GPS coordinates), pitch, roll, yaw, ground speed, humidity level, velocity, acceleration, and contingency information. The foregoing is not meant to be limiting, and other data may be captured and stored in the flight data logs. The flight data logs may be stored on a removable medium. The medium can be installed on the ground control system or onboard the UAV. The data logs may be wirelessly transmitted to the ground control system or to the FPS.

Modules, programs or instructions for performing flight operations, contingency maneuvers, and other functions may be performed with operating system 320. In some implementations, the operating system 320 can be a real time operating system (RTOS), UNIX, LINUX, OS X, WINDOWS, ANDROID or other operating system 320. Additionally, other software modules and applications may run on the operating system 320, such as a flight control module 322, contingency module 324, inspection module 326, database module 328 and mission module 329. In particular, inspection module 326 can include computer instructions that, when executed by processor 335, can cause processor 335 to control the UAV to perform solar panel inspection operations as described below. Typically, flight critical functions will be performed using the UAV primary computer system 300. Operating system 320 may include instructions for handling basic system services and for performing hardware dependent tasks.

In addition to the UAV primary computer system 300, the secondary computer system 302 may be used to run another operating system 372 to perform other functions. The UAV secondary computer system 302 can be a system of one or more computers, or software executing on a system of one or more computers, which is in communication with, or maintains, one or more databases. The UAV secondary computer system 302 can include a processing subsystem 390 of one or more processors 394, GPU 392, and I/O subsystem 393. The UAV secondary computer system 302 can include logic circuits, analog circuits, associated volatile and/or non-volatile memory, associated input/output data ports, power ports, etc., and include one or more software processes executing on one or more processors or computers. The UAV secondary computer system 302 can include memory 370. Memory 370 may include non-volatile memory, such as one or more magnetic disk storage devices, solid-state hard drives, flash memory. Other volatile memory such a RAM, DRAM, SRAM may be used for storage of data while the UAV is operational.

Ideally, modules, applications and other functions running on the secondary computer system 302 will be non-critical functions in nature. If the function fails, the UAV will still be able to operate safely. The UAV secondary computer system 302 can include operating system 372. In some implementations, the operating system 372 can be based on real time operating system (RTOS), UNIX, LINUX, OS X, WINDOWS, ANDROID or other operating system.

Additionally, other software modules and applications may run on the operating system 372, such as an inspection module 374, database module 376, mission module 378 and contingency module 380. In particular, inspection module 374 can include computer instructions that, when executed by processor 394, can cause processor 394 to control the UAV to perform solar panel inspection operations as described below. Operating system 372 may include instructions for handling basic system services and for performing hardware dependent tasks.

The UAV can include controllers 346. Controllers 346 may be used to interact with and operate a payload device 348, and other devices such as cameras 349A and 349B. Cameras 349A and 349B can include a still-image camera, video camera, infrared camera, multispectral camera, stereo camera pair. In addition, controllers 346 may interact with a Lidar, radio transceiver, sonar, laser ranger, altimeter, TCAS, ADS-B (Automatic dependent surveillance-broadcast) transponder. Optionally, the secondary computer system 302 may have controllers to control payload devices.

The UAV 100 illustrated in FIGS. 1-3 is an example provided for illustrative purposes. The UAV 100 in accordance with the present disclosure may include more or fewer components than are shown. For example, while a quadcopter is illustrated, the UAV 100 is not limited to any particular UAV configuration and may include hexacopters, octocopters, fixed wing aircraft, or any other type of independently maneuverable aircraft, as will be apparent to those of skill in the art having the benefit of the disclosure herein. Furthermore, the navigation of an autonomous UAV 100 may be guided by other types of vehicles (e.g., spacecraft, land vehicles, watercraft, submarine vehicles, etc.).

The following paragraphs describe systems and methods for correcting rolling shutter distortions in images captured by a UAV (or drone) with an integrated RTK/PPK module, utilizing motion data and geolocation information to enhance image accuracy and metadata integration. Although primarily discussed with reference to a UAV, it is appreciated that other types of vehicles (e.g., spacecraft, land vehicles, watercraft, submarine vehicles, etc.) could also be utilized for correcting rolling shutter distortions.

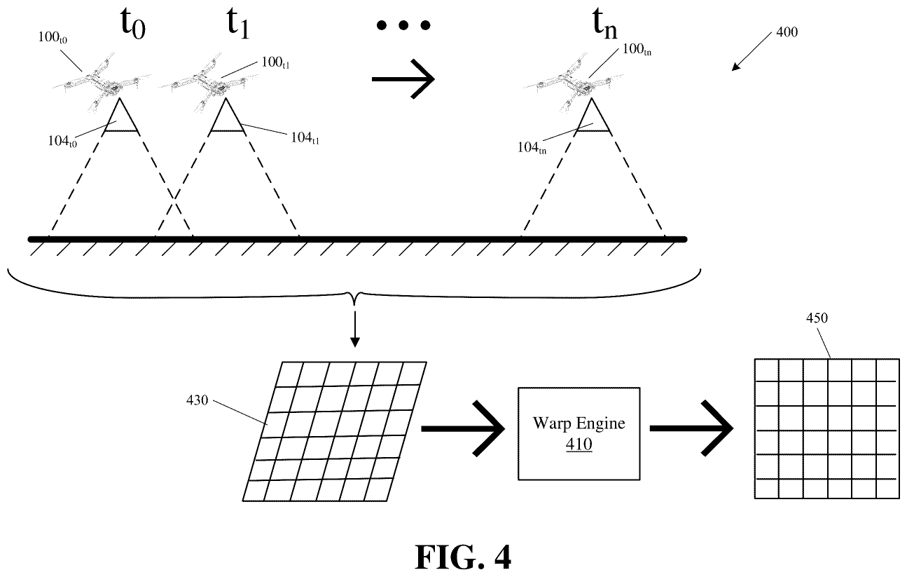

Referring now to FIG. 4, the schematic diagram illustrates the rolling shutter correction process, generally designated as 400. This process is integral to the system described, which focuses on correcting rolling shutter distortions in images captured by a drone. The diagram depicts a drone, labeled as 100, equipped with a camera, labeled as 104, moving along a trajectory over time, from an initial time t0 to a later time tn. As the drone progresses along this path, the rolling shutter camera captures a distorted image, labeled as 430. This distortion is typical of rolling shutter cameras, where different parts of the image are exposed at different times, leading to artifacts when the camera or subject is in motion.

The distorted image 430 is then input into a warp engine, labeled as 410. The warp engine is a component of the system, as it applies a correction to the distorted image to produce a geometrically accurate, corrected image, labeled as 450. This corrected image approximates what would be captured by a global shutter camera, which exposes the entire image simultaneously, thus eliminating the rolling shutter artifacts. The warp engine 410 utilizes a warp mesh generated based on pose data from an inertial measurement unit (IMU), per-row exposure time of the image sensor, and an assumed ground plane. This process ensures that the corrected image 450 is free from the distortions typically associated with rolling shutter cameras.

The components and their interactions in FIG. 4 are essential for achieving the objectives outlined. The drone 100, with its camera 104, captures images that are initially distorted due to the rolling shutter effect. The warp engine 410 processes these images, using data from the IMU and GNSS module, to correct the distortions and produce a corrected image 450. This corrected image is then stored along with metadata, including timestamp, corrected camera orientation, and geolocation. The system's ability to handle gimbal orientation changes and optimize corrected images for third-party photogrammetry packages further enhances its functionality, making it suitable for various applications, including real-time digital twin streaming and survey-grade geospatial data collection.

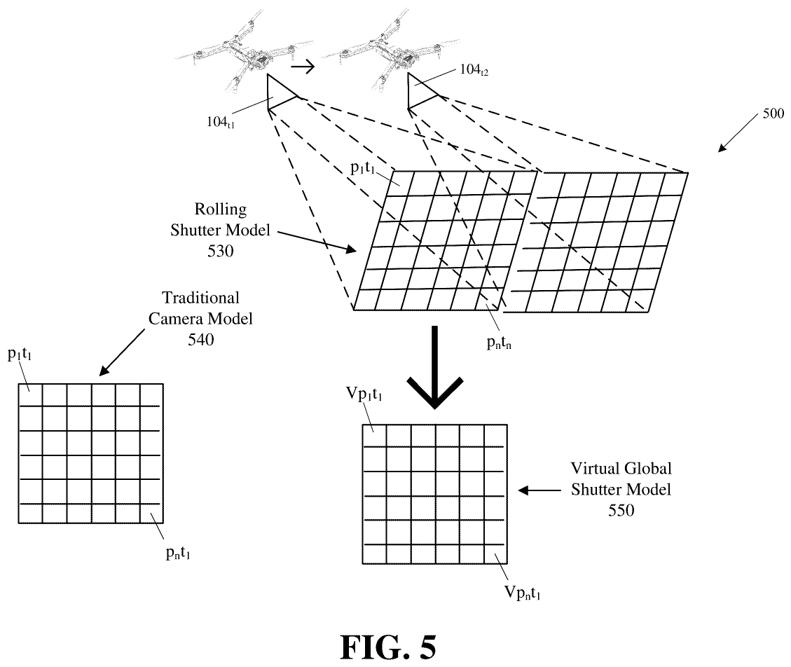

Referring now to FIG. 5, the diagram 500 illustrates the correction process for transforming images captured by a rolling shutter camera on a drone into a format that simulates a global shutter capture. The camera, labeled as 104, is mounted on a drone and captures images according to a rolling shutter model, denoted as 530. In this model, different parts of the image sensor are exposed at different times, leading to skewed or distorted images due to the motion of the drone during capture. This distortion is contrasted with the traditional camera model 540, which represents an idealized scenario where all parts of the sensor are exposed simultaneously, resulting in an undistorted image.

The process involves transforming the distorted image from the rolling shutter model 530 into a corrected image that conforms to a virtual global shutter model 550. This transformation is achieved by generating a warp mesh based on pose data from an inertial measurement unit (IMU), the per-row exposure time of the image sensor, and an assumed ground plane. The warp mesh is applied to the distorted image to correct rolling shutter artifacts, effectively approximating a global shutter capture where all pixels appear as if they were captured simultaneously.

The diagram further illustrates the comparison between the rolling shutter model and the virtual global shutter model. The rolling shutter model 530 shows the staggered exposure of the image sensor, while the virtual global shutter model 550 depicts the corrected image where the staggered exposure has been rectified. This correction process is crucial for applications requiring high precision, such as photogrammetry and 3D modeling, where accurate image representation is essential.

In the context of the system, the processor on the drone is configured to handle these corrections seamlessly, even when there are changes in gimbal orientation. The corrected images are stored with metadata that includes geolocation data derived from a global navigation satellite system (GNSS) module, ensuring that each image is accurately tagged with its position and orientation at the time of capture. This metadata is vital for further processing and integration into third-party photogrammetry packages, which assume a global shutter pinhole camera model. The system's ability to correct both rotational and translational artifacts enhances the quality and usability of the captured images, making it a robust solution for aerial imaging and surveying tasks.

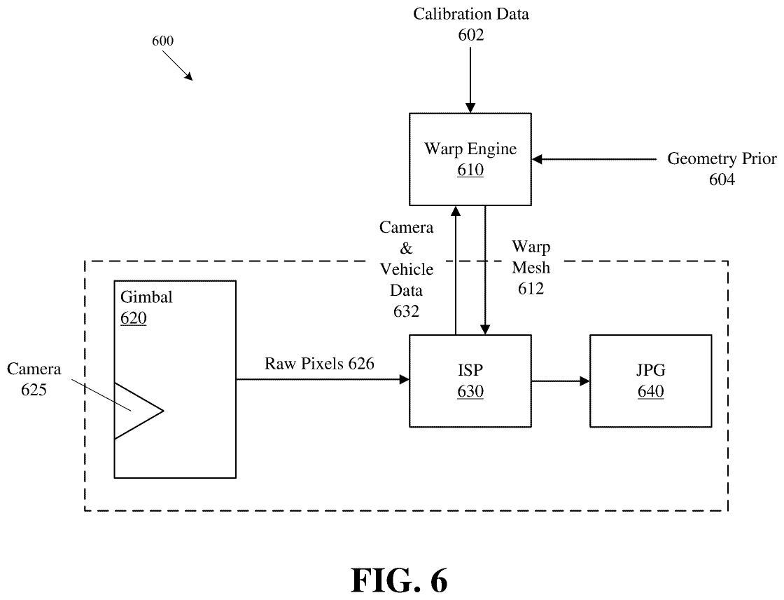

Referring now to FIG. 6, the block diagram illustrates an embodiment of the correction system 600, which is integral to the purpose of correcting rolling shutter distortions in drone-captured images. The system comprises several key components, each playing a role in the image correction process. At the heart of the system is the camera 625, mounted on a gimbal 620, which captures raw pixels 626. This setup allows for dynamic image capture while the drone is in motion, providing the initial data necessary for correction.

The warp engine 610 is a central component of the system, receiving multiple inputs to generate a warp mesh 612. These inputs include calibration data 602, which provides parameters for accurate correction, and a geometry prior 604, such as an assumed ground plane, which helps in estimating the scene geometry. Additionally, camera and vehicle data 632, which includes pose and position information from an inertial measurement unit (IMU) and a global navigation satellite system (GNSS), is fed into the warp engine. This data is crucial for understanding the drone's movement and orientation during image capture, allowing the warp engine to accurately model and correct rolling shutter artifacts.

Once the warp mesh 612 is generated, it is provided to the Image Signal Processor (ISP) 630. The ISP applies the correction to the raw pixels 626, effectively transforming them into a corrected image that approximates a global shutter capture. This corrected image can then be processed further, for example, by a JPG encoder 640, which prepares the image for storage or transmission. The system's ability to store both raw and corrected images, along with metadata such as timestamp, corrected camera orientation, and geolocation, ensures that the images are not only corrected but also enriched with valuable information for further analysis or use in photogrammetry applications.

The structural relationships among these components are designed to ensure seamless data flow and processing. The gimbal 620 allows for flexible camera orientation, which the processor can handle seamlessly when applying rolling shutter correction. The warp engine 610's interaction with the ISP 630 and the subsequent encoding by the JPG encoder 640 highlight the system's capability to integrate various data inputs and processing stages to achieve high-quality image correction. This integration is crucial for applications requiring precise geolocation and image accuracy, such as surveying and digital twin generation.

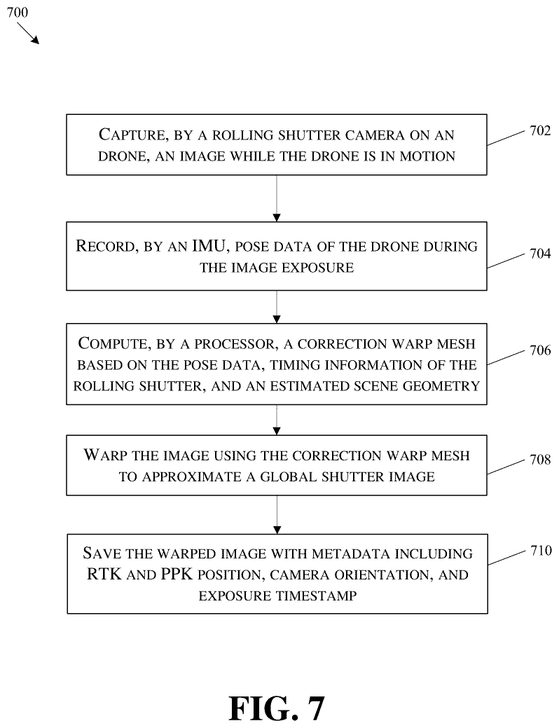

FIG. 7 is a flowchart illustrating a method 700 for correcting rolling shutter distortions in images captured by a drone, according to an embodiment. At step 702, an image may be captured by a rolling shutter camera on a drone while the drone is in motion. The rolling shutter camera may be integral to the drone, and the image capture may occur as the drone navigates through its environment. The drone's movement during image capture may introduce distortions that are characteristic of rolling shutter cameras. To address these distortions, the method may involve several subsequent steps.

At step 704, the process may continue with the recording of pose data by an inertial measurement unit (IMU) during the image exposure. The IMU may provide data regarding the drone's orientation and movement, which may be essential for subsequent correction processes. The IMU may be configured to provide detailed pose data of the drone, which can be crucial for understanding the orientation and movement of the drone at the time of image capture. This data may be used to inform subsequent image correction processes. The pose data may be recorded in conjunction with the drone's motion, allowing for a dataset that reflects the drone's dynamics during the exposure period. This information may be essential for generating a warp mesh that can correct rolling shutter artifacts, as it provides the necessary context for understanding how the drone's movement may have affected the image capture. The processor may utilize this pose data, along with other parameters such as the timing information of the rolling shutter and an estimated scene geometry, e.g., ground plane, to compute a correction warp mesh. This warp mesh may then be applied to the image to approximate a global shutter capture, effectively mitigating the distortions typically associated with rolling shutter cameras. The corrected image, along with the raw uncorrected image, may be stored with embedded metadata, including the timestamp, corrected camera orientation, and geolocation derived from the GNSS module. This metadata may enhance the utility of the images for various applications, such as photogrammetry or digital twin generation. The process may also involve dynamically updating the estimated scene geometry, e.g., estimated ground plane, using real-time vision-based altitude detection, which can further refine the accuracy of the warp mesh and the resulting corrected image. Additionally, compensation for motion blur may be achieved by determining the camera's motion during pixel exposure intervals using inertial data or successive images, and adjusting pixel values inversely to the determined motion. This approach to image correction may ensure that the final output is of high quality and suitable for a range of professional applications.

At step 706, the pose data, along with timing information of the rolling shutter and an estimated scene geometry, may be utilized by a processor to compute a correction warp mesh. This warp mesh may serve as a mathematical model to rectify the distortions introduced by the rolling shutter effect. This computation may be based on one or more of the pose data, timing information of the rolling shutter, and an estimated ground plane. The processor may utilize the pose data, which could be provided by an inertial measurement unit (IMU), to understand the orientation and movement of the drone during image capture. The timing information of the rolling shutter may be crucial in determining the exposure time for each row of pixels, which can affect the degree of distortion present in the captured image. The estimated scene geometry, e.g., estimated ground plane, may serve as a reference for correcting these distortions, allowing the processor to generate a warp mesh that can potentially correct rolling shutter artifacts. This warp mesh may be applied to the image to approximate a global shutter capture, thereby reducing the visual artifacts associated with the rolling shutter effect. The processor's ability to compute this warp mesh may be enhanced by considering additional data such as real-time vision-based altitude detection, which can dynamically update the estimated scene geometry. Furthermore, the processor may also compensate for motion blur by determining the camera's motion during pixel exposure intervals using inertial data or successive images, and adjusting pixel values inversely to the determined motion. This approach to image correction may ensure that the final output is a corrected image with minimized distortions, suitable for further processing or analysis.

Once the warp mesh is computed, at step 708, it may be applied to the captured image to approximate a global shutter image. This warping process may involve adjusting the image data to align with the corrected geometry, effectively mitigating the rolling shutter artifacts. The warp mesh, which is generated based on one or more of the pose data, timing information of the rolling shutter, and an estimated scene geometry, may be applied to the captured image. This application of the warp mesh may serve to correct rolling shutter artifacts, potentially resulting in an image that closely resembles one captured with a global shutter. The warp mesh may be computed using a depth-aware model, allowing different regions of the image to be warped according to estimated depth values. This process may involve the processor, which is configured to handle the computational aspects of generating and applying the warp mesh. The corrected image may then be stored with metadata, including geolocation data derived from the GNSS module, which may provide RTK or PPK positioning. This metadata may also include a description of the warp mesh used for correction, enabling reconstruction software to replicate or refine the applied correction. The processor may also be configured to correct motion blur in the captured image by modeling the camera's motion during each pixel's exposure interval and adjusting pixel values based on inertial measurement unit data or successive image frames. This correction may reduce both rotational and translational artifacts, enhancing the quality of the corrected image. The entire process may be part of a system designed to optimize images for third-party photogrammetry packages, assuming a global shutter pinhole camera model. The corrected images may be seamlessly integrated into photogrammetry workflows, providing high-quality data for further analysis and processing.

Lastly, at step 710, the corrected image may then be saved with metadata that includes RTK or PPK position, camera orientation, and exposure timestamp. This metadata may provide valuable context for the corrected image, enabling further processing or analysis.

Additionally, the method may incorporate dynamic updates to the estimated ground plane using real-time vision-based altitude detection. This step may enhance the accuracy of the correction by adapting to changes in the drone's altitude. Furthermore, compensation for motion blur may be achieved by determining the camera's motion during pixel exposure intervals using inertial data or successive images, and adjusting pixel values inversely to the determined motion. This compensation may further refine the image quality by addressing blurring effects caused by the drone's movement.

Overall, the method described in FIG. 7 may offer an approach to correcting rolling shutter distortions in drone-captured images, leveraging a combination of sensor data, computational models, and real-time adjustments to enhance image fidelity.

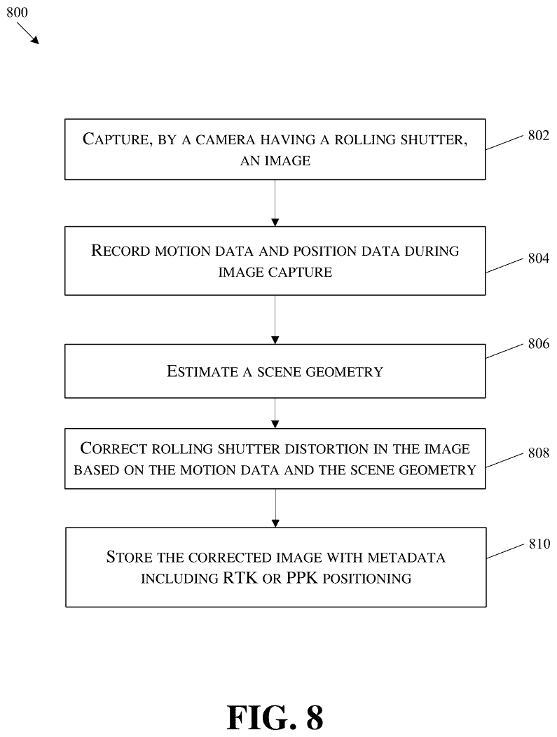

FIG. 8 is a flowchart illustrating a method 800 for correcting rolling shutter distortions in vehicle imagery, according to an embodiment. At step 802, an image may be captured by a drone camera equipped with a rolling shutter. This action may involve the drone being in motion, which can introduce rolling shutter artifacts due to the sequential exposure of the image sensor rows. The rolling shutter camera may be integral to the drone, allowing for aerial image capture. Subsequently, motion data and position data may be recorded during the image capture process. This data may be crucial for understanding the drone's movement and orientation at the time of image acquisition, which can be used to inform subsequent correction processes. The scene plane may then be estimated, which involves determining the geometric plane that represents the scene being captured. This estimation may be based on various inputs, such as motion data and position data, and may be essential for accurately correcting the rolling shutter distortion. The correction of rolling shutter distortion in the image may be performed based on the motion data and the estimated scene plane. This correction process may involve applying a warp mesh or similar technique to adjust the image, thereby approximating a global shutter capture. The corrected image may then be stored with metadata, which may include RTK or PPK positioning information. This metadata may provide valuable context for the corrected image, such as its geolocation and the conditions under which it was captured. Additionally, RTK corrections may be broadcast from the drone to a remote device, potentially enhancing the accuracy of geolocation data for other devices in the vicinity. This broadcasting capability may be part of the drone's functionality, allowing it to serve as a mobile base station for RTK corrections.

At step 804, the process may involve the recording of motion data and position data during the image capture by a drone camera equipped with a rolling shutter. This step may be crucial for ensuring that the subsequent image correction processes are accurately informed by the drone's movement and positioning at the time of capture. The motion data and position data may be utilized to estimate a scene plane, which can serve as a reference for correcting rolling shutter distortions in the captured image. The processor may compute a warp mesh based on this data, which may then be applied to the image to approximate a global shutter capture. This correction process may involve the reduction of both rotational and translational artifacts, potentially using velocity-based scene plane warping techniques. The corrected image, along with metadata including RTK or PPK positioning, may be stored for further use. This metadata may include geolocation information, which can be essential for applications requiring precise spatial data. Additionally, the system may be capable of broadcasting RTK corrections to a remote device, thereby enhancing the accuracy of geolocation data for other devices in the vicinity. This capability may be particularly useful in survey operations or other applications where high precision geolocation is required. The integration of these processes may enable the generation of corrected images that are optimized for use in third-party photogrammetry packages, assuming a global shutter pinhole camera model. The overall system may thus provide a solution for addressing rolling shutter distortions in drone-captured imagery, leveraging advanced data recording and correction techniques to enhance image quality and geospatial accuracy.

At step 806, the estimation of a scene plane may be undertaken. This process may involve the use of a processor to determine the plane depth below the drone, which can be achieved through various methods such as digital terrain models, takeoff altitude, or real-time vision estimation. The scene plane estimation may serve as an element for subsequent image correction processes, particularly in addressing rolling shutter distortions. The processor may utilize the estimated scene plane in conjunction with motion data to facilitate the correction of rolling shutter distortion in images. This correction process may involve the application of a warp mesh, which is generated based on the motion data and the estimated scene plane, to transform the image into a form that approximates a global shutter capture. The corrected image may then be stored with metadata, including geolocation data derived from RTK or PPK positioning, which may enhance the utility of the image for various applications, such as photogrammetry or digital twin generation. The estimation of the scene plane may also contribute to the reduction of errors caused by scene motion during image capture, as it provides a reference for adjusting the warp mesh to account for moving objects within the scene. This step may be integral to the overall system's capability to produce high-quality, distortion-free images that are suitable for precise geospatial analysis and modeling.

At step 808, the process may involve correcting rolling shutter distortion in an image based on motion data and a scene plane. The rolling shutter distortion, which can occur due to the sequential exposure of different parts of the image sensor, may be addressed by utilizing motion data that provides information about the movement of the drone or camera during image capture. This motion data, potentially derived from an inertial measurement unit (IMU) or similar device, may be crucial in understanding the dynamics of the camera's movement and thus in formulating an effective correction strategy. The scene plane, which may be an estimated representation of the ground or other reference surface, can serve as a basis for aligning the image correction process. By integrating the motion data with the scene plane, a processor may compute a warp mesh or similar corrective transformation that can be applied to the image. This transformation may adjust the image to approximate a global shutter capture, where all parts of the image are exposed simultaneously, thereby reducing or eliminating the rolling shutter artifacts. The corrected image may then be stored with metadata, which could include geolocation data such as RTK or PPK positioning, providing precise location information that may be essential for subsequent processing or analysis. This metadata may also encompass details about the camera orientation and exposure timestamp, further enriching the data set for potential use in applications like photogrammetry or digital twin generation. The process may also involve broadcasting RTK corrections from the drone to a remote device, which can enhance the accuracy of geolocation data for other systems or devices in the vicinity. This step, therefore, may represent a component in ensuring high-quality image capture and processing in systems utilizing rolling shutter cameras on drones.

At step 810, the process may involve storing the corrected image with metadata, which can include RTK or PPK positioning. This step may be crucial for ensuring that the corrected images are accurately geolocated, which can be essential for various applications such as mapping and surveying. The corrected image may be stored with geolocation metadata, which may provide precise location data derived from RTK or PPK geolocation techniques. This metadata may include information such as the timestamp and camera orientation, which can be embedded to enhance the utility of the corrected images.

Additionally, a sub-step associated with broadcasting RTK corrections from the drone to a remote device may be considered. This action may facilitate the provision of real-time kinematic corrections to other devices, potentially improving the accuracy of geolocation data for those devices. The broadcasting of RTK corrections may be an integral part of the system's functionality, allowing for enhanced precision in positioning data.

The process may also involve the dynamic updating of the estimated ground plane using real-time vision-based altitude detection. This action may ensure that the ground plane estimation remains accurate, which can be critical for the correction of rolling shutter distortions. The use of real-time vision-based altitude detection may allow for adjustments to be made on-the-fly, potentially improving the accuracy of the corrected images.

Furthermore, the compensation for motion blur by determining the camera's motion during pixel exposure intervals using inertial data or successive images may be included. This action may involve adjusting pixel values inversely to the determined motion, which can help in reducing motion blur in the corrected images. The use of inertial data or successive images may provide the necessary information to accurately compensate for motion blur, thereby enhancing the quality of the corrected images.

Overall, step 810 may encompass a series of actions that collectively contribute to the accurate storage and geolocation of corrected images, the broadcasting of RTK corrections, the dynamic updating of ground plane estimations, and the compensation for motion blur. These actions may be interrelated and may work together to ensure the effective functioning of the system in correcting rolling shutter distortions and enhancing the utility of the corrected images.

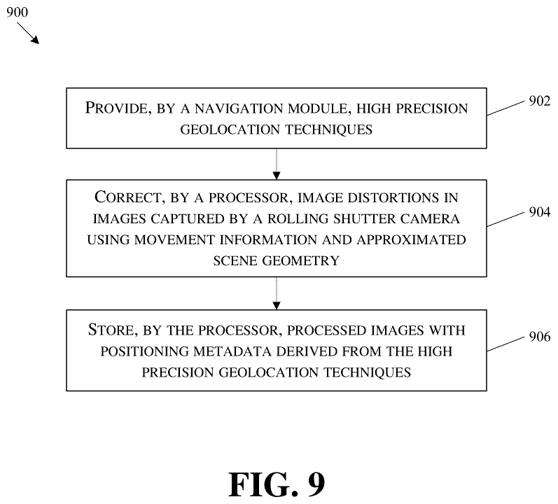

FIG. 9 is a flowchart illustrating a method 900 for correcting rolling shutter distortions in vehicle imagery, according to an embodiment. At step 902, the navigation module may provide high precision geolocation techniques. This may involve the use of real-time kinematic (RTK) or post-processed kinematic (PPK) geolocation to ensure accurate positioning data is available for subsequent processing steps. The navigation module may be integral in providing the necessary geolocation metadata that is crucial for the correction process.

Following this, at step 904, the processor may correct image distortions in images captured by a rolling shutter camera. This correction may be achieved by utilizing movement information and approximated scene geometry. The processor may generate a warp mesh based on the motion data and the estimated scene plane, which may be derived from various sources such as digital terrain models or real-time vision data. The warp mesh may then be applied to the images to correct rolling shutter artifacts, potentially resulting in images that approximate those captured by a global shutter camera.

In some implementations, the process of correcting image distortions may involve correcting image distortions in images captured by a rolling shutter camera using movement information and approximated scene geometry. The processor may be responsible for this correction, utilizing data from the rolling shutter camera. The correction process may involve generating a warp mesh to address rolling shutter artifacts, which may be based on the pose data, timing information of the rolling shutter, and an estimated ground plane. The warp mesh may then be applied to generate a corrected image that approximates a global shutter capture. This corrected image may be stored with metadata, including geolocation data derived from high precision geolocation techniques such as RTK or PPK. The metadata may also include timestamp and corrected camera orientation, which may be embedded to provide data for further processing or analysis. The processor may also handle gimbal orientation changes seamlessly during the rolling shutter correction process, ensuring that the orientation changes do not affect the quality of the corrected images. Additionally, the corrected images may be optimized for third-party photogrammetry packages, assuming a global shutter pinhole camera model, which may enhance their usability in various photogrammetric applications. The system may also be capable of reducing errors caused by scene motion during capture by identifying moving objects and adjusting the warp mesh accordingly. This capability may be achieved using data from prior or subsequent frames or a stored 3D model of the scene. The processor may also correct motion blur in the captured image by modeling the camera's motion during each pixel's exposure interval and adjusting pixel values based on inertial measurement unit data or successive image frames. This approach to image correction may ensure that the final output is of high quality and suitable for various applications, including real-time digital twin generation and three-dimensional reconstruction without requiring ground control points.

At step 906, the processor may store the processed images with positioning metadata derived from the high precision geolocation techniques. This metadata may include information such as the corrected camera orientation, geolocation, and timestamp, which may be embedded into the images. The storage of this metadata may facilitate the use of the corrected images in various applications, such as photogrammetry or digital twin generation.

In some implementations, the processor may be responsible for storing processed images with positioning metadata derived from high precision geolocation techniques. This process may involve the integration of data from various components to ensure accurate geolocation tagging of the images. The processor may utilize the geolocation metadata to embed precise location information into the images, which can be crucial for applications requiring high spatial accuracy. Additionally, the processor may broadcast real-time kinematic (RTK) corrections from the vehicle to a remote device, potentially enhancing the accuracy of geolocation data for other devices in the vicinity. This capability may be particularly useful in scenarios where multiple devices need to operate in a coordinated manner, relying on consistent and accurate geolocation data. Furthermore, the processor may generate a real-time digital twin using the processed images. This digital twin may serve as a continuously updated virtual representation of the environment, providing valuable insights and data for various applications. The generation of a digital twin may involve the integration of real-time data streams, allowing for dynamic updates and accurate modeling of the physical environment. The combination of storing processed images with precise geolocation metadata, broadcasting RTK corrections, and generating a real-time digital twin may offer a solution for applications requiring high precision and real-time environmental modeling.

Additionally, the method may include sub-steps to enhance the functionality of the system. One such sub-step may involve broadcasting real-time kinematic (RTK) corrections from the vehicle to a remote device. This capability may allow for the dissemination of precise geolocation data to other devices, potentially improving the accuracy of their positioning systems. Another sub-step may involve generating a real-time digital twin using the processed images. This digital twin may serve as a continuously updated 3D model of the environment, providing a dynamic representation that can be used for various analytical and monitoring purposes.

Overall, the method depicted in FIG. 9 may offer an approach to correcting rolling shutter distortions in vehicle imagery, leveraging high precision geolocation techniques and advanced image processing to produce corrected images with embedded metadata.

### Additional Embodiments

31. A system comprising: a drone including a rolling shutter camera; a navigation module configured to provide real-time kinematic (RTK) or post-processed kinematic (PPK) geolocation; and a processor configured to: correct rolling shutter distortions in images from the rolling shutter camera using motion data and an estimated scene plane; and store corrected images with geolocation metadata derived from the RTK or PPK geolocation.
32. A method comprising: capturing, by a drone camera having a rolling shutter, an image; recording motion data and position data during image capture; estimating a scene plane; correcting rolling shutter distortion in the image based on the motion data and scene plane; and storing the corrected image with metadata including RTK or PPK positioning.
33. A non-transitory computer-readable medium storing instructions that, when executed, cause a processor to: obtain image data from a rolling shutter camera; obtain motion and geolocation data during capture of the image; compute and apply a warp correction based on the motion data and an estimated plane; and output a corrected image with positioning metadata.
34. The system of claim 31, wherein the processor corrects both rotational and translational rolling shutter artifacts.
35. The system of claim 31, wherein the scene plane is estimated based on at least one of: takeoff altitude, terrain model, or real-time vision data.
36. The system of claim 31, wherein the corrected images are warped into a rectilinear camera model.
37. The system of claim 31, wherein the drone further operates as a survey instrument by performing at least one of: base station mode, differential level mode, total station mode, or laser scanning.
38. The method of claim 32, further comprising broadcasting RTK corrections from the drone to a remote device.
39. The method of claim 32, further comprising generating a real-time digital twin using the corrected images.
40. A system for correcting rolling shutter distortions in vehicle imagery, comprising: a navigation module configured to provide high precision geolocation techniques; a processor configured to: correct image distortions in images captured by a rolling shutter camera using movement information and approximated scene geometry; and store processed images with positioning metadata derived from the high precision geolocation techniques.
41. The system of claim 40, wherein the high precision geolocation techniques include at least one of real-time kinematic (RTK) or post-processed kinematic (PPK) geolocation.
42. The system of claim 40, wherein the movement information includes motion data captured during image acquisition.
43. The system of claim 40, wherein the approximated scene geometry includes an estimated scene plane.
44. The system of claim 40, wherein the processor is further configured to correct both rotational and translational rolling shutter artifacts.
45. The system of claim 43, wherein the estimated scene plane is determined based on at least one of takeoff altitude, a digital terrain model, or real-time vision data.
46. The system of claim 40, wherein the processor is further configured to warp the corrected images into a rectilinear camera model.
47. The system of claim 40, wherein the vehicle further operates as a survey instrument by performing at least one of base station mode, differential level mode, total station mode, or laser scanning.
48. The system of claim 40, wherein the processor seamlessly handles gimbal orientation changes when applying rolling shutter correction.
49. The system of claim 40, wherein the positioning metadata further includes a description of a warp mesh used for correction.
50. The system of claim 40, wherein the processed images are optimized for third-party photogrammetry packages assuming a global shutter pinhole camera model.
51. A method for correcting rolling shutter distortions in vehicle imagery, comprising: providing, by a navigation module, high precision geolocation techniques; correcting, by a processor, image distortions in images captured by a rolling shutter camera using movement information and approximated scene geometry; and storing, by the processor, processed images with positioning metadata derived from the high precision geolocation techniques.
52. The method of claim 51, further comprising broadcasting real-time kinematic (RTK) corrections from the vehicle to a remote device.
53. The method of claim 51, further comprising generating a real-time digital twin using the processed images.
54. The method of claim 51, further comprising dynamically updating the approximated scene geometry using real-time vision-based altitude detection.
55. The method of claim 51, wherein correcting image distortions includes reducing rotational artifacts using inertial measurement unit (IMU) data and reducing translational artifacts using velocity-based scene plane warping.
56. The method of claim 51, further comprising generating a three-dimensional reconstruction using the processed images without requiring ground control points.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (e.g., an angle that lies within the range of (approximately) 135° to (approximately) 225°). The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

As used herein, unless specifically stated otherwise, the term “or” encompasses all possible combinations, except where infeasible. For example, if it is stated that a component includes A or B, then, unless specifically stated otherwise or infeasible, the component may include only A, or only B, or A and B. As a second example, if it is stated that a component includes A, B, or C, then, unless specifically stated otherwise or infeasible, the component may include only A, or only B, or only C, or A and B, or A and C, or B and C, or A and B and C. Expressions such as “at least one of” do not necessarily modify an entirety of a following list and do not necessarily modify each member of the list, such that “at least one of A, B, and C” should be understood as including only A, or only B, or only C, or any combination of A, B, and C. The phrase “one of A and B” or “any one of A and B”shall be interpreted in the broadest sense to include one of A, or one of B.

The descriptions herein are intended to be illustrative, not limiting. Thus, it will be apparent to one skilled in the art that modifications may be made as described without departing from the scope of the claims set out below.

What is claimed is:

1. A system comprising:
a drone including a rolling shutter image sensor and a gimbal;
an inertial measurement unit (IMU) configured to provide pose data of the camera during an exposure;
a global navigation satellite system (GNSS) module configured to provide RTK or PPK positioning; and
a processor configured to:
generate a warp mesh to correct rolling shutter artifacts based on the pose data, a per-row exposure time of the image sensor, and an estimated scene geometry;
apply the warp mesh to generate a corrected image approximating a global shutter capture;
store both a raw uncorrected image and the corrected image; and
embed metadata including timestamp, corrected camera orientation, and geolocation derived from the GNSS module.

2. The system of claim 1 wherein the processor seamlessly handles gimbal orientation changes when applying rolling shutter correction.

3. The system of claim 1, wherein metadata further includes a description of the warp mesh used for correction.

4. The system of claim 1, wherein corrected images are optimized for third-party photogrammetry packages assuming a global shutter pinhole camera model.

5. The system of claim 1, wherein the processor is further configured to correct motion blur in the captured image by modeling the camera's motion during each pixel's exposure interval and adjusting pixel values based on inertial measurement unit data or successive image frames.

6. The system of claim 1, wherein the processor is further configured to reduce errors caused by scene motion during capture by identifying moving objects using at least one of: a prior frame, a subsequent frame, or a stored 3D model of the scene, and adjusting the warp mesh for pixels corresponding to the moving object.

7. The system of claim 1, wherein the warp mesh is computed using a multi-plane or depth-aware model, such that different regions of the image are warped according to estimated depth values derived from stereoscopic imagery, LiDAR, or an online SLAM system.

8. The system of claim 1, wherein the processor selectively stores either only the corrected image, only the raw image, or both, based on a user-selectable setting that toggles correction output modes.

9. The system of claim 1, wherein the metadata further includes exposure timing data, sensor readout direction, and environmental parameters affecting calibration, thereby enabling reconstruction software to replicate or refine the applied correction.

10. The system of claim 1, wherein the corrected image is tagged with survey-grade geospatial metadata including at least one of: ellipsoidal altitude, RTK ambiguity status, number of satellites used, or geodetic dilution of precision (GDOP).

11. The system of claim 1, wherein the processor is further configured to detect ground control point (GCP) markers in the image and update the embedded geolocation metadata of the corrected image based on the known coordinates of the marker.

12. The system of claim 1, wherein the processor is further configured to operate in a base station mode, such that the drone, when stationary on or above a known reference point, logs GNSS observations and broadcasts RTK corrections to other rovers.

13. The system of claim 1, wherein the processor is further configured to operate in a total station mode, wherein the gimbal directs a camera or range sensor at a target point, and the processor computes the coordinates of the target point using the drone's RTK position and orientation.

14. The system of claim 1, wherein the processor is further configured to operate in a differential leveling mode, wherein the drone compares its reference altitude at a first location to the altitude of a second location observed by its sensors to determine elevation difference.

15. The system of claim 1, wherein the processor is further configured to perform a real-time digital twin streaming mode, wherein corrected images and associated metadata are processed onboard and transmitted in real-time to generate a continuously updated 3D model of the environment.

16. A method comprising:
capturing, by a rolling shutter camera on a drone, an image while the drone is in motion; recording, by an IMU, pose data of the drone during the image exposure;
computing, by a processor, a correction warp mesh based on the pose data, timing information of the rolling shutter, and an estimated scene geometry;
warping the image using the correction warp mesh to approximate a global shutter image; and
saving the warped image with metadata including RTK or PPK position, camera orientation, and exposure timestamp.

17. The method of claim 16, wherein the estimated scene geometry comprises an estimated ground plane, the method further comprising dynamically updating the estimated ground plane using real-time vision-based altitude detection.

18. The method of claim 16, wherein the correction reduces rotational artifacts using IMU data and reduces translational artifacts using velocity-based scene plane warping.

19. The method of claim 16, further comprising generating a three-dimensional reconstruction using the corrected images without requiring ground control points.

20. The method of claim 16, further comprising compensating for motion blur by determining the camera's motion during pixel exposure intervals using inertial data or successive images, and adjusting pixel values inversely to the determined motion.

21. The method of claim 16, further comprising correcting for scene motion by identifying a moving object using at least one of a prior image, a subsequent image, or a known scene model, and adjusting the warp for pixels corresponding to the moving object.

22. The method of claim 16, wherein computing the warp mesh further comprises using a multi-plane or depth-aware model, wherein different portions of the image are warped according to depth estimates obtained from stereoscopic imagery, LiDAR, or SLAM-based depth mapping.

23. The method of claim 16, further comprising storing both a raw image and the corrected image, or alternatively only one of them, based on a user-selectable mode toggle.

24. The method of claim 16, wherein saving the metadata further includes embedding at least one of: exposure timing data, sensor readout direction, or environmental parameters used to generate the warp mesh.

25. The method of claim 16, further comprising detecting a ground control point (GCP) marker within the image and refining the image geolocation metadata based on the known coordinates of the marker.

26. The method of claim 16, further comprising operating the drone in a base station mode, wherein the drone, while stationary, logs GNSS data and transmits RTK corrections to other devices.

27. The method of claim 16, further comprising operating the drone in a total station mode, wherein the drone directs a gimbal-mounted sensor toward a target point and computes the coordinates of the target using the drone's RTK position and orientation.

28. The method of claim 16, further comprising operating the drone in a differential leveling mode, wherein the drone determines an elevation difference between two locations by comparing its reference altitude to an observed point's altitude using gimbal and onboard sensors.

29. The method of claim 16, further comprising streaming corrected images and associated metadata in real time to generate a continuously updated digital twin of the environment.

30. An apparatus comprising:
one or more non-transitory computer-readable medium; and
instructions, stored on the one or more non-transitory computer-readable medium that, when executed by a processor, cause the processor to:
determine a plane depth below the drone using at least one of: digital terrain model, takeoff altitude, or real-time vision estimation;
compute a warp mesh for rolling shutter correction based on the determined plane depth and drone motion during exposure;
apply the warp mesh to the image; and
output both the corrected image and the raw image with associated geolocation metadata.
